(19) United States
(12) Patent Application Publication
(10) Pub. No.: US 2022/0121855 A1
(43) Pub. Date: Apr. 21, 2022

(54) TEMPORAL KNOWLEDGE DISTILLATION FOR ACTIVE PERCEPTION

(71) Applicants: Mohammad Farhadi, Tempe, AZ (US); Yezhou Yang, Tempe, AZ (US)

(72) Inventors: Mohammad Farhadi, Tempe, AZ (US); Yezhou Yang, Tempe, AZ (US)

(73) Assignee: Arizona Board of Regents on behalf of Arizona State University, Scottsdale, AZ (US)

(21) Appl. No.: 17/504,257

(22) Filed: Oct. 18, 2021

Related U.S. Application Data
(60) Provisional application No. 63/092,643, filed on Oct. 16, 2020.

(51) Int. Cl. G06K 9/00; G06K 9/46; G06K 9/62; G06N 3/08; G06N 3/04

(52) U.S. Cl. CPC G06K 9/00744; G06K 9/4671; G06N 3/0454; G06N 3/08; G06K 9/6262

(57) ABSTRACT

Temporal knowledge distillation for active perception is provided. Despite significant performance improvements in object detection and classification using deep structures, they still require prohibitive runtime to process images and maintain the highest possible performance for real-time applications. Observing that a human visual system (HVS) relies heavily on temporal dependencies among frames from visual input to conduct recognition efficiently, embodiments described herein propose a novel framework dubbed as temporal knowledge distillation (TKD). The TKD framework distills temporal knowledge gained from a heavy neural network-based model over selected video frames (e.g., the perception of the moments) for a light-weight model. To enable the distillation, two novel procedures are described: 1) a long-short term memory (LSTM)-based key frame selection method; and 2) a novel teacher-bounded loss design.

### RELATED APPLICATIONS

This application claims the benefit of provisional patent application Ser. No. 63/092,643, filed Oct. 16, 2020, the disclosure of which is hereby incorporated herein by reference in its entirety.

### GOVERNMENT SUPPORT

This invention was made with government support under 1750082 awarded by the National Science Foundation. The government has certain rights in the invention.

### FIELD OF THE DISCLOSURE

The present disclosure relates to machine learning, and more particularly to machine learning for perception in video data.

### BACKGROUND

Object detection plays a critical role in a variety of mobile robot tasks, such as obstacle avoidance, detection and tracking, and object searching. During the last decade, convolutional neural network (CNN)-based methods have achieved great success in the object detection task. This success has led researchers to explore deeper models such as RetinaNet (as described in T.-Y. Lin, P. Goyal, R. Girshick, K. He, and P. Dollar, “Focal Loss for Dense Object Detection,” in IEEE Transactions on Pattern Analysis and Machine Intelligence, 2018) or Faster R-CNN (as described in S. Ren, K. He, R. Girshick, and J. Sun, “Faster R-CNN: Towards Real-time Object Detection with Region Proposal Networks,” in Advances in Neural Information Processing Systems, pages 91-99, 2015), which yield high recognition accuracy.

The “secret” sauce behind the success of these deeper and deeper CNN models is the stacking of repetitive layers and increasing the number of model parameters. This practice becomes possible while the applications are running on infrastructures with high processing capabilities. However, the disadvantages of this practice are obvious, and the high performance is achieved by the significant growth of the model complexity: stacking up layers and increasing the model parameters which are computationally expensive and also increase the inference time significantly. Hence, these models are not suitable for real-time and embedded visual processing systems, and thus impede their deployment in the era of intelligent robots and autonomous vehicles. The same concerns also lie in the energy conservation and computation limits, since deep models require a large number of matrix multiplications, which are time-consuming and energy-demanding for mobile applications.

The aforementioned concerns trigger various approaches, such as using the alignment of memory and single instruction, multiple data (SIMD) operations to boost matrix operations. More recently, some studies proposed transferring the knowledge of deep models to shallow models while maintaining the recognition accuracy. Although these approaches do improve the model efficiency, they ignore the temporal dependencies among the frames from dynamic scenes, which is one of the critical capabilities to maintain high recognition accuracy while being energy aware.

### SUMMARY

Temporal knowledge distillation for active perception is provided. Deep neural network-based methods have been proved to achieve outstanding performance on object detection and classification tasks. Despite this significant performance improvement using deep structures, they still require prohibitive runtime to process images and maintain the highest possible performance for real-time applications. Observing that a human visual system (HVS) relies heavily on temporal dependencies among frames from visual input to conduct recognition efficiently, embodiments described herein propose a novel framework dubbed as temporal knowledge distillation (TKD).

The TKD framework distills temporal knowledge gained from a heavy neural network-based model over selected video frames (e.g., the perception of moments) for a light-weight model. To enable the distillation, two novel procedures are described: 1) a long-short term memory (LSTM)-based key frame selection method; and 2) a novel teacher-bounded loss design. To validate this approach, comprehensive empirical evaluations are conducted using different object detection methods over multiple datasets including the YouTube-Objects and Hollywood scene datasets. The results show consistent improvement in accuracy-speed tradeoffs for object detection over the frames of the dynamic scene, compared to other modern object recognition methods. Certain embodiments can maintain the desired accuracy with a throughput of around 220 images per second.

An exemplary embodiment provides a method for detecting objects in video data. The method includes receiving an image frame, performing object detection on the image frame using a student model, determining whether the image frame is a key frame, and if the image frame is a key frame, retraining the student model with an oracle model.

Another exemplary embodiment provides a convolutional neural network (CNN) with TKD. The CNN includes a student model configured to perform object detection on input image frames; an oracle model configured to provide retraining of the student model; and a key frame selector configured to activate the oracle model to retrain the student model if one or more key frames output by the student model fall below an expected accuracy.

Another exemplary embodiment provides an embedded computing device for detecting objects in video data, the embedded computing device comprising: a memory storing a series of video frames; and a first processing device configured to: receive the series of video frames; perform object detection using a student model trained by an oracle model; evaluate accuracy of the student model over a number of key frames; and retrain the student model with the oracle model if the student model falls below an expected accuracy.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a graphical representation of performance of an embodiment of a temporal knowledge distillation (TKD) model over example object categories in different environments.

FIG. 2 is a schematic diagram of an exemplary embodiment of TKD.

FIG. 3 is a schematic diagram illustrating a procedure of creating a target tensor for a loss function.

FIG. 4 is a graphical representation of key frames selected using an exemplary embodiment of TKD over two scenes from the Hollywood scene dataset.

FIG. 5 is a graphical representation of accuracy and speed results from the YouTube-Objects dataset for different training methods.

FIG. 6 is a graphical representation comparing computational costs for the proposed loss function with a previous approach.

FIG. 7 is a graphical representation of a histogram of key frames for a moving camera and a fixed camera.

FIG. 8 is a flow diagram illustrating a process for detecting objects in video data.

FIG. 9 is a flow diagram illustrating another process for detecting objects in video data.

FIG. 10 is a block diagram of an embedded system suitable for implementing a TKD model according to embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Temporal knowledge distillation for active perception is provided. Deep neural network-based methods have been proved to achieve outstanding performance on object detection and classification tasks. Despite this significant performance improvement using deep structures, they still require prohibitive runtime to process images and maintain the highest possible performance for real-time applications. Observing that a human visual system (HVS) relies heavily on temporal dependencies among frames from visual input to conduct recognition efficiently, embodiments described herein propose a novel framework dubbed as temporal knowledge distillation (TKD).

The TKD framework distills temporal knowledge gained from a heavy neural network-based model over selected video frames (e.g., the perception of moments) for a light-weight model. To enable the distillation, two novel procedures are described: 1) a long-short term memory (LSTM)-based key frame selection method; and 2) a novel teacher-bounded loss design. To validate this approach, comprehensive empirical evaluations are conducted using different object detection methods over multiple datasets including the YouTube-Objects and Hollywood scene datasets. The results show consistent improvement in accuracy-speed tradeoffs for object detection over the frames of the dynamic scene, compared to other modern object recognition methods. Certain embodiments can maintain the desired accuracy with a throughput of around 220 images per second.

### I. Introduction

The motivation for the TKD model described herein comes from the visual adaptation phenomenon observed in the HVS. Visual adaption involves temporary changes in the HVS when exposed to an intense or new stimulus and by the lingering aftereffects when the stimulus is removed. Other studies show that the HVS adapts to changes in an environment, and this adaptation can happen in a few milliseconds.

More specifically, one study revealed that the facial recognition process in humans happens at a higher level of cognition. At the later stage of visual encoding, it is observed that the HVS adapts itself to a prevailing environment. This shows that the HVS relies heavily on a prior estimation of objects' appearance distribution to improve perception capability at a current point in time.

Moreover, adaptation of the HVS occurs with both “low” and “high” level visual features. The HVS adapts to the distribution of “low-level” visual features such as color, motion, and texture, as well as “high-level” visual features such as face classification including identity, gender, expression, or ethnicity. This adaptation can be both short-term and long-term. For instance, the HVS adapts itself to the general visual features of the environment in which a person lives for a long time such as faces and colors (similar to training a model). Also, the HVS can adapt itself dynamically when the environment changes, such as when moving from an indoor to an outdoor environment (similar to adapting a shallow model). This adaptation capability is essential for the HVS to perform recognition well and efficiently, with low energy consumption.

Inspired by the aforementioned findings, the TKD framework described herein is designed to utilize knowledge distillation techniques. In an exemplary aspect, the TKD transfers temporal knowledge from a heavy model (e.g., oracle model) to a light model to boost visual processing efficiency while maintaining the heavy model's performance.

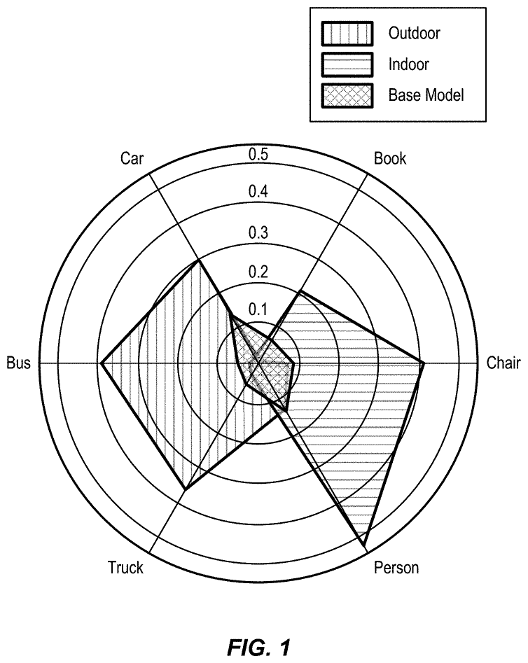

FIG. 1 is a graphical representation of performance of an embodiment of the TKD model over example object categories in different environments. This figure shows how TKD improves recognition accuracy (illustrated with an F₁ score distribution) over different scenes, compared to an oracle model, which is assumed to be a perfect model. Also, the baseline model is shown, which is a tiny model with low accuracy compared to oracle recognition due to a much lower number of parameters.

TKD achieves higher accuracy by adapting itself to the observed environment. In the case of an indoor scene, the TKD recognition accuracy improves significantly over objects which are more probable to be observed inside a building. In the outdoor case, TKD recognition accuracy improves over objects such as a car, bus, and truck which are more probable to be observed outside. For a similar amount of model parameters as the baseline tiny model, the TKD will achieve much better performance over the more probable objects by dynamically learning from the oracle model.

### II. Knowledge Distillation for Classification

The conventional use of knowledge distillation has been proposed for training CNN-based classification models. These models use a dataset (xᵢ, yᵢ), i=1, 2, . . . , n where xᵢ and yᵢ are input images and the class labels. The student model is trained to optimize the following general loss function (with β as a modulation factor):

Oₛ=Student(x);Oₜ=Teacher(x),

L(Oₛ(y,Oₜ))=βL_{gt}(Oₛ,y)+(1−β)Lₜ(Oₛ,Oₜ) Equation 1

where Lₜ is the loss using teacher output Oₜ and L_{gt} is the loss using ground truth y.

In addition to the classification task, object detection also could benefit from the knowledge distillation procedure. However, it's not as straightforward as the classification task. Most notably, the teacher model's output may yield misleading guidance to the student model. The teacher regression result can be contradictory to the ground truth labels, also the output from the teacher regression module is unbounded.

To address these issues, embodiments described herein use a novel and bio-inspired way of adopting the teacher model's knowledge. Namely, temporally estimating the expectation of object labels, their sizes, and shapes based on the previously observed frames or E[yᵢ|α₁, α₂, . . . , αᵢ₋₁] where yᵢ is a given object's label and a the observations. This expectation changes in time by camera or object movements, and/or the changing of the field of view. Here, this extracted knowledge is used to improve object detection performance.

Rather than aiming to improve the feature extractor or general knowledge of the student model, embodiments optimize the decoder inside the student model to adapt it to the current environment. This is done by increasing the likelihood of objects which are more frequently found from the previous observations. Since the model requires online training during the inference stage, it should be able to address the following challenges:
1. Training is a time consuming procedure, running it at the inference stage hurts model efficiency.
2. Selecting the key frames accurately on which the student model needs to be adapted.
3. Objects with low appearance probability may not be detected by the student model after adaptation.
4. The oracle model still introduces noise at locations where there are no objects. Simply training the student model with noisy oracle output decreases the accuracy.

The following section introduces an exemplary embodiment of this approach to address these challenges respectively.

### III. Temporal Knowledge Distillation (TKD) Approach

As mentioned in Section I, the overall objective of the TKD system is to estimate the expectation of object labels, their sizes, and shapes on the temporal domain and to improve the performance of the student model. Following this intuition, a mechanism is put forward with a combination of an oracle model (which is considered as the best possible model) and a student model (which is fast but has considerably lower accuracy compared to the oracle). The temporal knowledge of the oracle model is transferred to the student model at the inference time. By transferring this knowledge, the student model adapts itself to the current environment or scene.

Without loss of generality, an exemplary embodiment adopts Yolo-v3 (as teacher) and Tiny-Yolo v3 (as student) as the base object detection methods (as described in J. Redmon and A. Farhadi, “Yolo-v3: An Incremental Improvement,” arXiv preprint arXiv:1804.02767, 2018). These two models are one-stage object detection models. In both models, object detection is conducted at various layers. The middle layers are used to detect large objects and the last layers to detect small objects. This strategy successfully improves the object detection accuracy with a significant edge. The Yolo-v3 object detection model is selected as the oracle model due to its reliable and dominating performance compared with other one-stage methods. The Tiny-Yolo model is selected as the student model due to its high base frame rate and having a similar model structure with the Yolo-v3.

A. The TKD Architecture

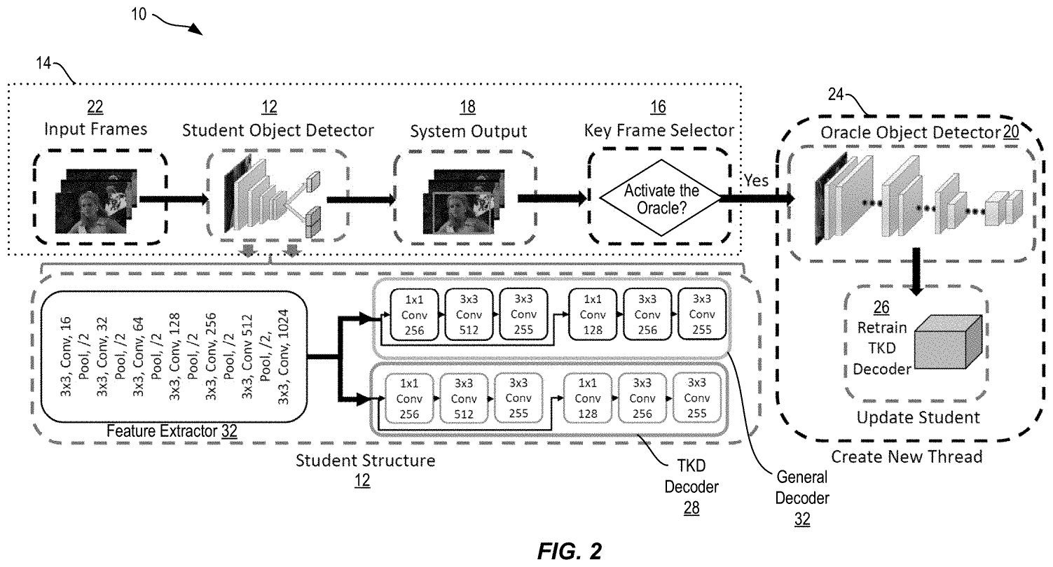

FIG. 2 is a schematic diagram of an exemplary embodiment of TKD 10. A low-cost student model 12 is tasked to detect objects in a main thread 14. To retain high accuracy, a key frame selector 16 decides (e.g., based on a system output 18 of the main thread 14) whether to activate an oracle model 20 and adapt the student model 12 over the environment of one or more input frames 22. If activated, a new thread 24 is created to execute the oracle model 20 and update or retrain 26 the student model 12 (e.g., by retraining a TKD decoder 28 of the student model 12). Since the execution of the oracle model 20 and retraining the student model 12 occurs in a separate thread, it does not have a significant effect on the inference latency of the main thread 14.

The student model 12 includes a feature extractor 30 which feeds two decoders, the TKD decoder 28 and a general decoder 32. In some embodiments, the pre-trained Yolo-v3 is adopted as the oracle model 20. The oracle model 20 is run with the one or more input frames 22, and the weights of the student's TKD decoder 28 get updates at specific input frames 22 from results of the oracle model 20. A decision procedure is designed using an LSTM model to generate the signals that indicate the right timing to use the oracle knowledge.

Specifically, an exemplary embodiment trains the Tiny-Yolo with a general decoder 32 over the COCO dataset (as described in T.-Y. Lin, M. Maire, S. Belongie, J. Hays, P. Perona, D. Ramanan, P. Dollár, and C. L. Zitnick, “Microsoft COCO: Common Objects in Context,” in Computer Vision-ECCV 2014, pages 740-755, Springer, 2014). The design of Tiny-Yolo has two general decoders to improve the accuracy of different object sizes. First, a copy is made of the general decoders bounded together as the TKD decoder 28. The TKD decoder 28 is updated during the inference stage. Only the last three layers of Tiny-Yolo are updated and it is treated as the decoder, since it yields enough performance in practice. The general decoder 32 from Tiny-Yolo is kept together with the TKD decoder 28 to make the final detection. The TKD decoder 28 and the general decoder 32 are executed in two parallel threads, which does not increase latency. This will preserve the chance of detecting viable objects addressing challenge (3) in Section II.

B. Distillation Loss

Before describing the distillation loss used by embodiments of the present disclosure, a brief overview of other distillation loss functions is provided. One approach uses a combination of hint procedure and weighted loss function. This approach generates boxes and labels using both the student and the teacher model, then calculates two loss values comparing the teacher's output and the ground truth. In the end, the weighted loss values are summed up. If the student model outperforms the teacher model, training is continued only using ground-truth supervision.

Another approach applied a similar procedure to one-stage object detection models. This approach generates bounding boxes and labels, and applies non-maximum suppression (NMS) to these boxes and then follows the loss function to optimize the student model. The loss is defined in the following equation:

L_{final}=L_{bb}^{C}(bᵢ^{gt},\hat{b}ᵢ,bᵢ^{T},oᵢ^{T})+Lcl^{C}(pᵢ^{gt},\hat{p}ᵢ,pᵢ^{T},oᵢ^{T})+L_{obj}^{C}(oᵢ^{gt},ôᵢ,oᵢ^{T}) Equation 2

where L_{bb}^{C}, L_{cl}^{C}, L_{obj}^{C} are objectness loss, classification loss, and regression loss which are calculated using both ground truth and the teacher output. Also, \hat{b}ᵢ, \hat{p}ᵢ, ôᵢ are bounding box coordinates, class probability and objectness of the student model. bᵢ^{gt}, pᵢ^{gt}, oᵢ^{gt} and bᵢ^{T}, pᵢ^{T}, oᵢ^{T} of are values derived from ground truth and the teacher model output.

It is observed herein that the detection layer is the most computationally expensive part of the Yolo-v3 and Tiny-Yolo models. In this layer, several processes are done (sorting, applying softmax to classification cells, removing low confidence boxes, etc.) to produce bounding boxes and then applying NMS to these boxes. These processes are computationally slow due to the multiple steps of processing, and also running over CPU by the implementation. Consequently, directly adopting these loss functions will also be computationally expensive during the inference stage.

With this observation, the mean square error (MSE) between tensors generated by the student decoder and the oracle decoder should be the fastest method for distillation loss. However, the side effects are also notorious. The oracle model generates noises over some parts of frame which have no object existences; hence directly forcing the student model to retrain will hurt its performance.

Another approach could be calculating the MSE between the tensor cells which have high confidence of object existence. But the approach will hurt the student's recognition accuracy too. By applying this loss function, the student model tends to generate redundant detection boxes which yield a larger number of false positives.

To alleviate the downsides of both loss designs and still to preserve their advantages, embodiments described herein introduce a novel distillation loss by a combination of them in Equation 3:

L_{final}=Σ∥Tₛ^{H}−∥₂²+Σ∥Tₛ^{E}−((λ*Tₛ^{E})+((1−λ)*Tₒ^{E})∥₂² Equation 3

where Tₛ^{H} and Tₒ^{H} are the student and oracle cells with a high chance of object existences and Tₛ^{E} and Tₒ^{E} are the cells with a low expectation. More specifically, the first part on the left side of Equation 3 calculates the MSE between the parts which have high confidence of objects. The second part calculates a modulated MSE between the cells with a low expectation from both the oracle output tensor and the student output tensor. Here, λ is the modulation factor.

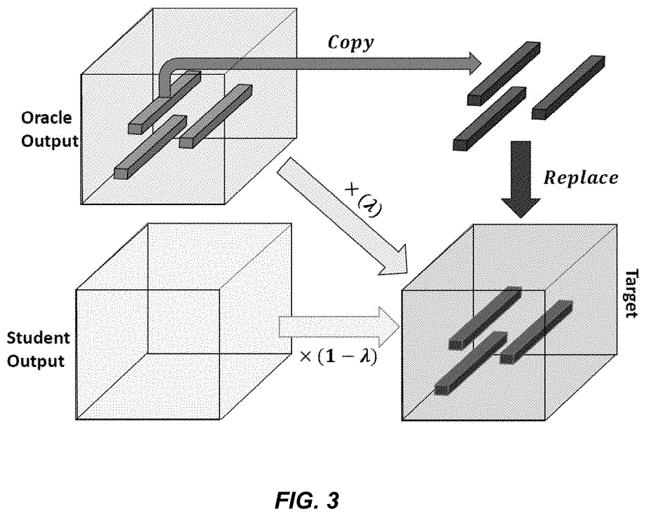

FIG. 3 is a schematic diagram illustrating a procedure to create the target tensor for the loss function. By using this loss function, the student model will have a lower chance to generate extra false positives. Also, it would not strictly force the student model to mimic the oracle exactly. The aim is to partially address the challenges 1) and 4) in Section II, with such a fast and effective loss function.

C. Key Frame Selection

Another crucial module to enable TKD to work properly is a procedure to demonically (e.g., with decaying momentum) select the time instances to train the student model during the inference stage. Specifically, TKD seeks the frames that by training over them the model has a higher expectation of reducing the loss, thus eventually improving the detection accuracy. For the rest of this disclosure, these frames are denoted the key frames.

Selecting a larger number of frames as the key frames will hurt the performance since re-training is computationally expensive, while selecting too few frames will hurt the detection accuracy as the student may not align well with the oracle model in time. Thus, an effective and fast procedure to select the key frames is highly desired to yield a positive effect on the system's performance.

A key frame selection procedure is proposed which is both efficient and also practical. First, the training prevention factor τ is checked. If the student model has been trained in any last τ frames, the key selection procedure is exited. This is based on the reasonable assumption that if there is an environment change, it typically takes τ frames for this change to be fully observable. Thus, when the student is trained, training for the next τ frames would not be beneficial.

Second, the decision process is started as formulated in Equations 4:

$$I ∈ \{ 0 , 1 \} \{ \begin{matrix}0 & Do not distill knowledge \\ 1 & Distill knowledge\end{matrix} \\ I = LSTM ( {F}_{S} ) ⩔ {I}_{R} , {I}_{R} ∼ B ( 2 , {P}_{t} ) , \\ {P}_{t} = \{ \begin{matrix}max ( ( {P}_{t - 1} - 0.05 ) , 0.05 ) & Δ L < σ \\ min ( 2 {P}_{t - 1} , 1.0 ) & Δ L > σ\end{matrix} \qquad Equations 4$$

where I is the indicator that denotes the final decision. It takes the disjunction of the LSTM's output and the random module's output. The features extracted from the student model F_{S} (the last layer before the decoder) are passed to the LSTM module (with one LSTM layer and one fully connected layer) which outputs a signal indicating to train the student model or not. Note that another binary random module I_{R} (with binomial distribution B(2, pₜ)) is introduced, which decides in a random fashion to train the student model or not. The random procedure is added as a safeguard in case the LSTM model outputs a sequence of erroneous decisions.

In the end, the LSTM module is updated based on the result feeding back after the training procedure. If the LSTM makes a correct decision where the observed loss decrease ΔL<σ (for evaluations described in Section IV set σ=−0.1), the random factor Pₜ will be reduced by 0.05. If the LSTM model makes a wrong decision, the LSTM model is updated and the random factor Pₜ is doubled.

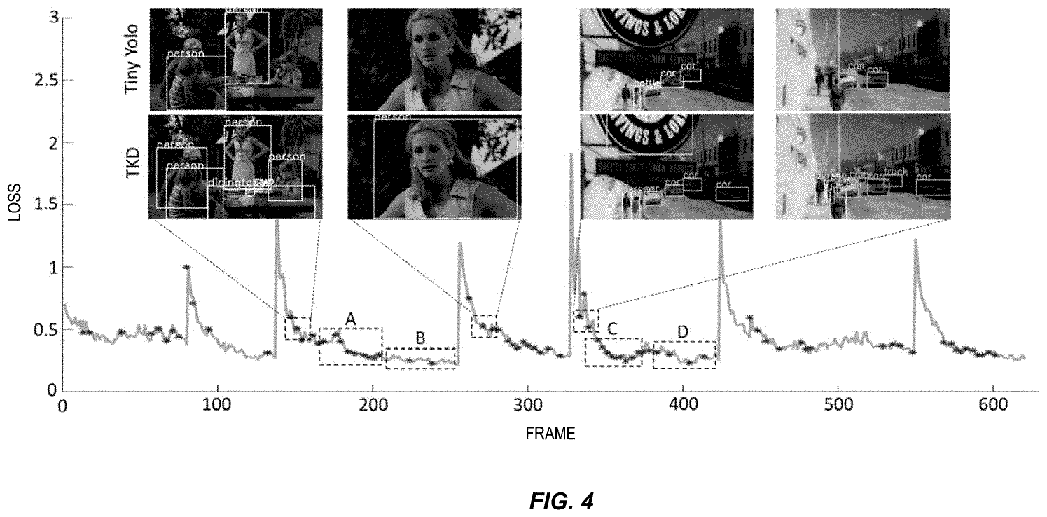

FIG. 4 is a graphical representation of key frames selected using an exemplary embodiment of TKD over two scenes from the Hollywood scene dataset (described in M. Marszałek, I. Laptev, and C. Schmid, “Actions in context,” in IEEE Conference on Computer Vision & Pattern Recognition, 2009). The darker stars indicate the key frames selected by this embodiment, as further discussed in Section IV.C. Knowledge distillation is applied selectively to a small number of frames which partially addresses the aforementioned challenges 1) and 2) in Section II.

### IV. Evaluation

The presented framework suggests three hypotheses that deserve empirical tests: 1) TKD can perform visual recognition efficiently, without hurting the recognition performance significantly; 2) the novel loss function can improve online training of the decoder; and 3) with the TKD frame selector mechanism, the overall system yields the best performance over other key-frame selection mechanisms by locating the key frames more accurately (frames which training over them can improve TKD accuracy).

To validate these three hypotheses, an embodiment of TKD is evaluated on the Hollywood scene dataset, YouTube-Objects dataset (as described in A. Prest, C. Leistner, J. Civera, C. Schmid, and V. Ferrari, “Learning Object Class Detectors from Weakly Annotated Video,” in Computer Vision and Pattern Recognition (CVPR), 2012 IEEE Conference, pages 3282-3289, IEEE, 2012), The Pursuit of Happyness (G. Muccino, The Pursuit of Happyness, 2008) and The Office (G. Daniels, The Office, 2013). All the base models (RetinaNet, Faster R-CNN, Yolo-v3, and Tiny-Yolo) are trained over the MS COCO dataset.

An embodiment of TKD is implemented as described in Section III with two different configurations. First, the process of inference and distillation are performed sequentially among the same thread; the other way, the distillation is performed in a separate thread and run the student and oracle in parallel, with both architectures implemented using a PyTorch environment (as described in A. Paszke, S. Gross, S. Chintala, G. Chanan, E. Yang, Z. DeVito, Z. Lin, A. Desmaison, L. Antiga, and A. Lerer, Automatic Differentiation in PyTorch, 2017.). All evaluations are carried out on one single NVIDIA TITAN X Pascal graphics card.

Hollywood scene dataset has 10 classes of scenes distributed over 1152 videos. In this dataset, videos are collected from 69 movies. The length of these video clips is from 5 seconds to 180 seconds. The length and diversity of video clips make this dataset a perfect candidate to evaluate the key selector method and the novel loss function.

YouTube-Objects dataset is a weakly annotated dataset from YouTube videos, 10 object classes of the PASCAL VOC Challenge (as described in M. Everingham, L. Van Gool, C. K. Williams, J. Winn, and A. Zisserman, “The Pascal Visual Object Classes (VOC) Challenge,” International Journal Of Computer Vision, 88(2):303-338, 2010) has been used in this dataset. It contains 9 and 24 video clips for each object class, and the length of these videos are between 30 seconds to 3 minutes. This dataset is used to evaluate TKD's overall performance due to its high-quality objects level annotations.

The Pursuit of Happyness is a famous movie and The Office is a famous television series. Both contain several scenes which have smooth transitions. The Pursuit of Happyness serves a great testbed since it has scenes in different locations such as office, street, etc. It is also closer to a real world scenario from a camera of the intelligent agent. Also, The Office is selected as most of the scenes have been recorded in the same location which make it suitable for testing the novel loss function.

A. Ablation Study

Table 1 compares different strategies to highlight the effectiveness of the proposed novel loss and key frame selector. The output of the oracle model is considered as ground truth and different methods are evaluated over it. Here, five methods are compared: 1) TKD with random key frame selection; 2) TKD with Scene Change detection; 3) Tiny-Yolo without any training; 4) Combination of Tiny-Yolo and Yolo-v3 without training; 5) TKD with the proposed key frame selection method.

TABLE 1
Performance of TKD with different training methods

| | Hollywood Scene Dataset | | | | | |
|---|---|---|---|---|---|---|
| | IOU = 0.5 | | IOU = 0.6 | | IOU = 0.75 | |
| Method | AP | F₁ | AP | F₁ | AP | F₁ |
| Random Selection | 0.71 | 0.75 | 0.54 | 0.68 | 0.48 | 0.49 |
| Scene Change Detection | 0.68 | 0.58 | 0.47 | 0.50 | 0.23 | 0.35 |
| Tiny-Yolo | 0.45 | 0.16 | 0.38 | 0.14 | 0.10 | 0.28 |
| Tiny-Yolo (73%) + | 0.60 | 0.49 | 0.59 | 0.49 | 0.44 | 0.46 |
| Yolo-v3 (27%) | | | | | | |
| TKD | 0.75 | 0.76 | 0.58 | 0.69 | 0.49 | 0.50 |
| | The Pursuit of Happyness | | | | | |
| | IOU = 0.5 | | IOU = 0.6 | | IOU = 0.75 | |
| Method | AP | F₁ | AP | F₁ | AP | F₁ |
| Random Selection | 0.65 | 0.65 | 0.55 | 0.58 | 0.35 | 0.43 |
| Scene Change Detection | 0.54 | 0.58 | 0.45 | 0.53 | 0.35 | 0.44 |
| Tiny-Yolo | 0.37 | 0.11 | 0.25 | 0.10 | 0.08 | 0.06 |
| Tiny-Yolo (73%) + | 0.58 | 0.47 | 0.52 | 0.43 | 0.39 | 0.44 |
| Yolo-v3 (27%) | | | | | | |
| TKD | 0.73 | 0.67 | 0.59 | 0.61 | 0.40 | 0.46 |

In the following evaluations, the λ is set to be 0.4, which is obtained heuristically. Section IV.A presents the findings which were observed in search for the best A.

Random Selection: Here, instead of selecting key frames by the proposed method, the decision module selects frames purely randomly for further processing. During the testing phase, the probability is set to be 27% (to make sure it selects more frames than the TKD approach (25% on average)). Random selection achieves 0.75 F₁ score (IOU=0.5) in the Hollywood scene dataset and achieves 0.65 F₁ score (IOU=0.5) in the Pursuit of Happyness. On average, it reaches a frame-rate of 89 frames per second (FPS).

Scene Change Detection: This method uses the content-aware scene detection method. It finds areas where the difference between two subsequent frames exceeds the threshold value and used them as key frames for training the student. The threshold with the highest performance and accuracy is selected to report. This method achieves 0.58 F₁ score and 0.58 F₁ score in the Hollywood scene dataset and The Pursuit of Happyness respectively. This method selected 24% frames as key frames ultimately. On average, the system yields a 93 FPS.

Tiny-Yolo without any training: Tiny-Yolo is tested to show the accuracy of a strong baseline model without temporal knowledge distillation. This model achieves 0.16 F₁ score and 0.11 F₁ score in the Hollywood scene dataset and The Pursuit of Happyness respectively, which are significantly lower than the other mentioned methods. However, this model has 220 FPS, the fastest among all the models.

Tiny-Yolo+Yolo-v3 without training: In this configuration, Tiny-Yolo and Yolo-v3 v3 were used together. A random procedure is designed, which runs Yolo-v3 with a probability of 27% and Tiny-Yolo for the rest of the times. This model achieves 0.49 F₁ score and 0.47 F₁ score in the Hollywood scene dataset and the Pursuit of Happyness respectively. Frame-rate approaches 89 FPS.

TKD with the proposed key frame selection method: Initially, τ (the training prevention factor) is set to 2 (the transition between two scenes is observed to take at least 2 frames) and the minimum random selection is set to 5%. In the Hollywood dataset, the method of embodiments of TKD selects around 26% of frames and the F₁ score achieves 0.76 (IOU=0.5). In the Pursuit of Happyness movie, this method selects around 24% of frames and the F₁ score reaches 0.67 (IOU=0.5). On average, the system achieves a frame-rate of 91 FPS sequentially and 220 FPS when running inference and knowledge distillation in parallel.

Table 1 lists the evaluation results observed with these variants. These evaluations show that the TKD, while maintaining a similar frame-rate as other methods, can achieve higher recognition accuracy. To further validate this claim, one additional evaluation is conducted on a single-shot movie, where TKD selects 21% and random procedure selects 27% of the total frames for re-training. They reach comparable F₁ scores (TKD: 0.807, Random: 0.812), but the TKD method uses 10,400 frames less than the random one.

B. Overall Performance

Table 2 shows mean average precision (mAP) and F₁ scores for five different object detection models as well as the TKD method over the YouTube-Objects dataset. The student models without oracles supervision are trained to the best performance that could be achieved. Not surprisingly, larger or deeper models with larger numbers of parameters perform better than shallower models, while smaller models run faster than larger ones. However, TKD achieves a high detection accuracy compared to RetinaNet, Faster R-CNN, Tiny-Yolo, and the combination of Tiny-Yolo and Yolo-v3 (same configuration which is described in Section IV.A). TKD's detection performance also approaches the performance of the oracle model (Yolo-v3). In this evaluation, 25% of frames have been selected for training using the proposed key frames selection method.

TABLE 2
Compression of accuracy over YouTube-Objects dataset

IOU = 0.5

| Method | mAP | F₁ score |
|---|---|---|
| RetinaNet-50 | 0.45 | 0.44 |
| Faster R-CNN | 0.52 | 0.50 |
| Tiny-Yolo | 0.38 | 0.33 |
| Tiny-Yolo (73%) + Yolo-v3 (27%) | 0.44 | 0.45 |
| TKD | 0.56 | 0.55 |

Oracle (Teacher)

| | | |
|---|---|---|
| Yolo-v3 | 0.60 | 0.62 |

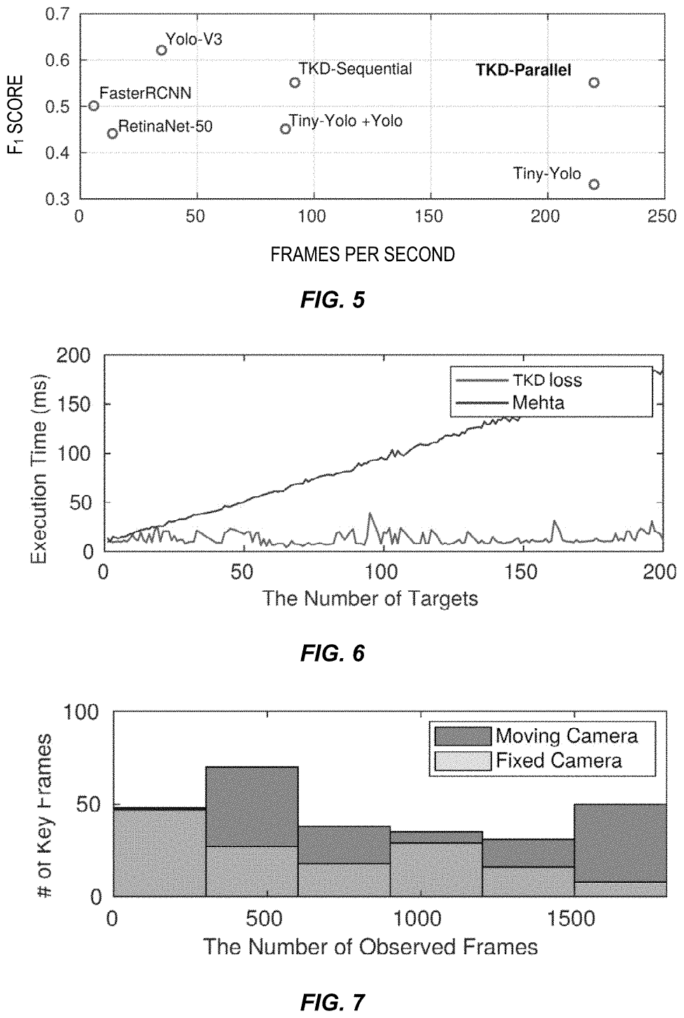

FIG. 5 is a graphical representation of accuracy and speed results from the Youtube-Objects dataset for different training methods. It can be observed that the TKD archives higher accuracy compared to other shallow methods while still operating far above the real-time speeds with a 91 FPS. The oracle model has a better detection accuracy, but it runs much slower than the TKD.

C. Further Study and Discussions

This section provides further insight into the loss function design, the general knowledge distillation idea, and suggested application of the proposed method.

Loss function: the λ effect is studied over the number of true positives and false positives generated by TKD. All tests are done over an episode of The Office. This video is chosen since it was recorded in one indoor environment, with a consistent object distribution. Table 3 shows the student model's detection accuracy varies with the different choices of λ. At λ=0, a lower number of false positives are observed since a fewer number of frames (5%) are selected by the key frame selection module. With a low λ (except at 0), an increase in false positives is observed as the model tries to generate more boxes and the loss function doesn't punish enough onto the student model for generating false positives. With a high A, drops in the true positive rates are observed since the student is forced to learn noises which are likely introduced by the oracle model. Consequently, 0.4 is empirically the best choice here, and it is set as the λ value for all the evaluations.

TABLE 3
Parameter study of λ over the TKD

| ssd | | 0 | 0.2 | 0.4 | 0.6 | 0.8 | 1 |
|---|---|---|---|---|---|---|---|
| IOU 0.5 | AP | 0.47 | 0.72 | 0.82 | 0.83 | 0.79 | 0.8 |
| | F₁ | 0.36 | 0.649 | 0.676 | 0.656 | 0.634 | 0.643 |

| | | | | | | |
|---|---|---|---|---|---|---|
| #TP | 3353 | 8570 | 8371 | 7806 | 7274 | 7438 |
| #FP | 215 | 2952 | 1522 | 1129 | 814 | 841 |

To validate the loss design, its performance is further compared with the one from Mehta et al. (as described in R. Mehta and C. Ozturk, “Object Detection at 200 Frames per Second,” arXiv preprint arXiv:1805.06361, 2018), where the proposed loss is based on the NMS algorithm. It is computationally more expensive in comparison with the TKD approach.

FIG. 6 is a graphical representation comparing computational costs for the proposed loss function with a previous approach (Mehta). This figure illustrates that an increasing number of targets from each frame will result in increasing execution time for calculating the loss function in Mehta. The loss design has an almost constant execution time, while the loss function in Mehta is linearly growing.

Temporal knowledge distillation: Here, a closer look at the key selection module is provided. FIG. 4 shows its performance over two video clips from the Hollywood scene dataset. Crosses indicate frames selected by the proposed method as key frames. At peaks, there is a scene change and logically these points would be the best candidate for training. Following this insight, the model is observed to have a lag on detecting these points. Thus, training over these frames is not the best approach for improving the student model's accuracy. The scene detection method can identify these points yet table 1 shows it achieves lower accuracy. FIG. 4 shows the TKD after detecting a change in loss start stabilizing the model by selecting most of the frames (parts A & C) and for the rest selecting a smaller number of frames (parts B & D).

FIG. 7 is a graphical representation of a histogram of key frames for a moving camera and a fixed camera. The proposed key frame selection method leads to improved performance. FIG. 7 shows that the number of selected key frames is adjusted based on the domain change. With the fixed camera case in which the domain does not change, the number of selected frames decreases along observing more frames (validated over the UCF Crime dataset described in W. Sultani, C. Chen, and M. Shah, “Real-World Anomaly Detection in Surveillance Videos,” in Proceedings Of The IEEE Conference On Computer Vision And Pattern Recognition, pages 6479-6488, 2018). Indeed, for the case of a moving camera, more key frames are selected to adjust the TKD to the specific domain.

For further evaluation, TKD is applied on one episode of The Office television series. Then, the trained student model is tested over another episode without any re-training at the inference time. An increase of precision by 6% is observed as compared to the case in which the original student model is used without applying TKD. The result demonstrates the domain adaption capability of this method. Furthermore, it maintains a high recall over other domains which indicates that unseen objects have a chance to be detected.

### V. Process for Detecting Objects in Video Data

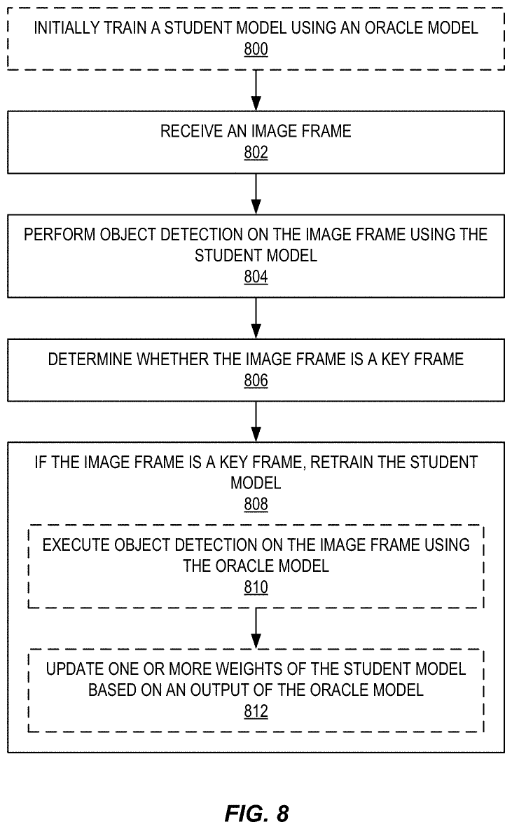

FIG. 8 is a flow diagram illustrating a process for detecting objects in video data. The process optionally begins at operation 800, with initially training a student model using an oracle model. In an exemplary aspect, the oracle model provides object detection at a higher accuracy than the student model, and the student model provides object detection at a lower cost than the oracle model. The process continues at operation 802, with receiving an image frame. In an exemplary aspect, a number of image frames (representing video data) may be received and processed sequentially. The process continues at operation 804, with performing object detection on the image frame using the student model. The process continues at operation 806, with determining whether the image frame is a key frame.

The process continues at operation 808, with, if the image frame is a key frame, retraining the student model with the oracle model. Operation 808 optionally includes operation 810, with executing object detection on the image frame using the oracle model. Operation 808 optionally includes operation 812, with updating one or more weights of the student model based on an output of the oracle model.

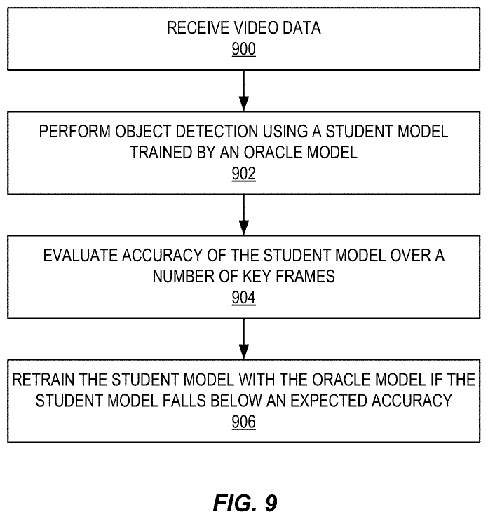

FIG. 9 is a flow diagram illustrating another process for detecting objects in video data. The process begins at operation 900, with receiving the video data. In an exemplary aspect, the video data is received and processed in real time. In some examples, the video data is received from a memory. The process continues at operation 902, with performing object detection using a student model trained by an oracle model. The process continues at operation 904, with evaluating accuracy of the student model over a number of key frames. The process continues at operation 906, with retraining the student model with the oracle model if the student model falls below an expected accuracy.

Although the operations of FIGS. 8 and 9 are illustrated in a series, this is for illustrative purposes and the operations are not necessarily order dependent. Some operations may be performed in a different order than that presented. Further, processes within the scope of this disclosure may include fewer or more steps than those illustrated in FIGS. 8 and 9.

### VI. Computer System

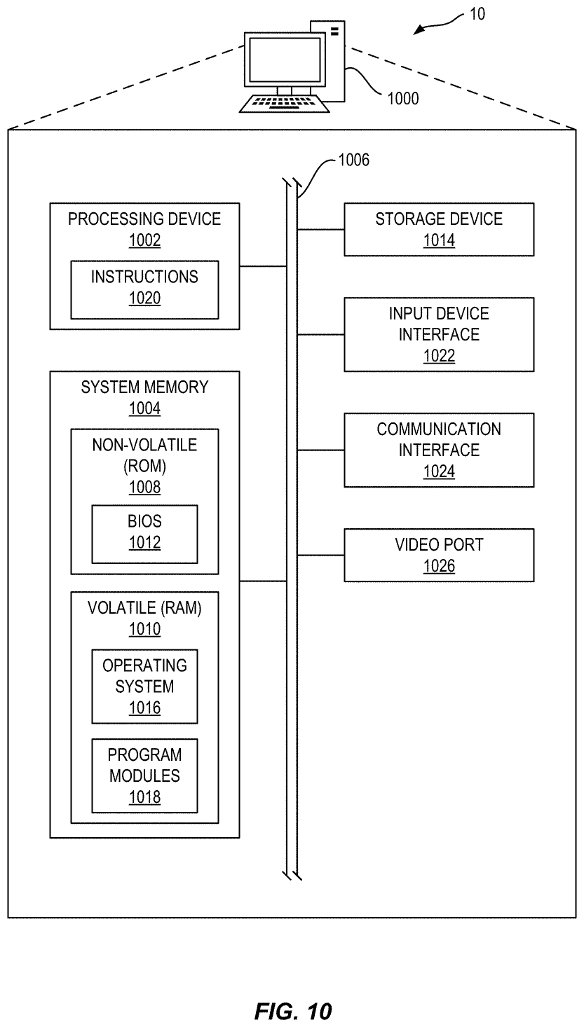

FIG. 10 is a block diagram of an embedded system 10 suitable for implementing a TKD model according to embodiments disclosed herein. The embedded system 10 includes or is implemented as a computer system 1000, which comprises any computing or electronic device capable of including firmware, hardware, and/or executing software instructions that could be used to perform any of the methods or functions described above, such as classifying an image. In this regard, the computer system 1000 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 1000 in this embodiment includes a processing device 1002 or processor, a system memory 1004, and a system bus 1006. The system memory 1004 may include non-volatile memory 1008 and volatile memory 1010. The non-volatile memory 1008 may include read-only memory (ROM), erasable programmable read-only memory (EPROM), electrically erasable programmable read-only memory (EEPROM), and the like. The volatile memory 1010 generally includes random-access memory (RAM) (e.g., dynamic random access memory (DRAM), such as synchronous DRAM (SDRAM)). A basic input/output system (BIOS) 1012 may be stored in the non-volatile memory 1008 and can include the basic routines that help to transfer information between elements within the computer system 1000.

The system bus 1006 provides an interface for system components including, but not limited to, the system memory 1004 and the processing device 1002. The system bus 1006 may be any of several types of bus structures that may further interconnect to a memory bus (with or without a memory controller), a peripheral bus, and/or a local bus using any of a variety of commercially available bus architectures.

The processing device 1002 represents one or more commercially available or proprietary general-purpose processing devices, such as a microprocessor, central processing unit (CPU), or the like. More particularly, the processing device 1002 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 1002 is configured to execute processing logic instructions for performing the operations and steps discussed herein.

In this regard, the various illustrative logical blocks, modules, and circuits described in connection with the embodiments disclosed herein may be implemented or performed with the processing device 1002, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 1002 may be a microprocessor, or may be any conventional processor, controller, microcontroller, or state machine. The processing device 1002 may also be implemented as a combination of computing devices (e.g., a combination of a DSP and a microprocessor, a plurality of microprocessors, one or more microprocessors in conjunction with a DSP core, or any other such configuration).

The computer system 1000 may further include or be coupled to a non-transitory computer-readable storage medium, such as a storage device 1014, which may represent an internal or external hard disk drive (HDD), flash memory, or the like. The storage device 1014 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 1016 and any number of program modules 1018 or other applications can be stored in the volatile memory 1010, wherein the program modules 1018 represent a wide array of computer-executable instructions corresponding to programs, applications, functions, and the like that may implement the functionality described herein in whole or in part, such as through instructions 1020 on the processing device 1002. The program modules 1018 may also reside on the storage mechanism provided by the storage device 1014. As such, all or a portion of the functionality described herein may be implemented as a computer program product stored on a transitory or non-transitory computer-usable or computer-readable storage medium, such as the storage device 1014, volatile memory 1010, non-volatile memory 1008, instructions 1020, and the like. The computer program product includes complex programming instructions, such as complex computer-readable program code, to cause the processing device 1002 to carry out the steps necessary to implement the functions described herein.

An operator, such as the user, may also be able to enter one or more configuration commands to the computer system 1000 through a keyboard, a pointing device such as a mouse, or a touch-sensitive surface, such as the display device, via an input device interface 1022 or remotely through a web interface, terminal program, or the like via a communication interface 1024. The communication interface 1024 may be wired or wireless and facilitate communications with any number of devices via a communications network in a direct or indirect fashion. An output device, such as a display device, can be coupled to the system bus 1006 and driven by a video port 1026. Additional inputs and outputs to the computer system 1000 may be provided through the system bus 1006 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A method for detecting objects in video data, the method comprising:
receiving an image frame;
performing object detection on the image frame using a student model;
determining whether the image frame is a key frame; and
if the image frame is a key frame, retraining the student model with an oracle model.

2. The method of claim 1, further comprising initially training the student model using the oracle model prior to performing the object detection.

3. The method of claim 1, wherein the oracle model provides object detection at a higher accuracy than the student model.

4. The method of claim 1, wherein the student model provides object detection at a lower cost than the oracle model.

5. The method of claim 1, wherein retraining the student model with the oracle model comprises:
executing object detection on the image frame using the oracle model; and
updating one or more weights of the student model based on an output of the oracle model.

6. The method of claim 5, further comprising executing object detection on a second image frame using the student model in parallel with executing the object detection on the image frame using the oracle model.

7. The method of claim 1, wherein the student model comprises a general decoder and a temporal knowledge distillation (TKD) decoder.

8. The method of claim 7, wherein retraining the student model with the oracle model comprises adapting the TKD decoder to an environment of the image frame.

9. The method of claim 1, wherein determining whether the image frame is a key frame comprises determining the image frame is a key frame only if the student model has not been trained in a last r number of frames.

10. The method of claim 9, wherein determining whether the image frame is a key frame further comprises determining the image frame is a key frame if accuracy of the student model on the image frame falls below an expected accuracy.

11. A convolutional neural network (CNN) with temporal knowledge distillation (TKD), the CNN comprising:
a student model configured to perform object detection on input image frames;
an oracle model configured to provide retraining of the student model; and
a key frame selector configured to activate the oracle model to retrain the student model if one or more key frames output by the student model fall below an expected accuracy.

12. The CNN of claim 11, wherein the oracle model is further configured to provide an initial training of the student model.

13. The CNN of claim 11, wherein the student model and the key frame selector are executed in a main thread of the CNN.

14. The CNN of claim 13, wherein activation of the oracle model causes the oracle model to be executed in a new thread of the CNN.

15. The CNN of claim 14, wherein new thread executes object detection using the oracle model and retrains the student model based on an output of the oracle model.

16. The CNN of claim 14, wherein the main thread and the new thread are configured to be operated in parallel.

17. The CNN of claim 11, wherein the student model comprises a TKD detector and a general detector, each of which performs object detection on the input image frames.

18. The CNN of claim 17, wherein the TKD detector and the general detector are configured to be executed in parallel.

19. The CNN of claim 17, wherein the TKD detector and the general detector receive features of an input image from a feature extractor.

20. An embedded computing device for detecting objects in video data, the embedded computing device comprising:
a memory storing a series of video frames; and
a first processing device configured to:
receive the series of video frames;
perform object detection using a student model trained by an oracle model;
evaluate accuracy of the student model over a number of key frames; and
retrain the student model with the oracle model if the student model falls below an expected accuracy.
